(19) United States
(12) Patent Application Publication
(10) Pub. No.: US 2024/0339815 A1
(43) Pub. Date: Oct. 10, 2024

(54) DUAL POWER TRANSFER SWITCH

(71) Applicant: ABB SCHWEIZ AG, Baden (CH)

(72) Inventors: Jianwei Li, Jiangmen (CN); Huaming Xia, Zhangzhou (CN); Yihua Chen, Xiamen (CN); Deyun Zhang, Xiamen (CN)

(21) Appl. No.: 18/745,491

(22) Filed: Jun. 17, 2024

Related U.S. Application Data
(63) Continuation of application No. PCT/CN2022/074763, filed on Jan. 28, 2022.

(51) Int. Cl. H02B 1/04; H02B 1/30

(52) U.S. Cl. CPC H02B 1/04; H02B 1/30

(57) ABSTRACT

A dual power transfer switch includes a contact system, which has a contact main shaft rotatably arranged to move contact assemblies. The contact main shaft has a first closed position, a second closed position, and an open position. At the first closed position, the contact assemblies connect a first power source to a load. At the second closed position, the contact assemblies connect a second power source to the load. At the open position, the contact assemblies disconnects from the load. The dual power transfer switch also includes a contact main shaft locking device configured to keep the contact main shaft at the open position. The contact main shaft locking device includes a locking link and a first actuator. The dual power transfer switch includes a contact main shaft interlock device.

### FIELD

Embodiments of the present disclosure generally relate to the field of a dual power transfer switch, and more particularly, to a dual power transfer switch with interlock devices.

### BACKGROUND

A dual power transfer switch is widely used in a power distribution cabinet for changeover of two power supplies to ensure continuously providing power to critical loads. A bypass type device typically contains two dual power transfer switches, i.e., a first transfer switching equipment (TSE, also referred as a dual power transfer switch) and a second transfer switching equipment, each of which comprises two switches to switch the loads between the two power supplies. The first transfer switching equipment and the second transfer switching equipment are substantially the same and one is used to operate in a normal condition in which the loads receive power from mains supply and the other is used to operate in a maintenance condition in which the first transfer switching equipment needs maintenance and the loads receive power from a backup power supply (for example a generator).

A structure of the TSE is generally very complex and can be operated automatically and manually. In an automatic mode, the TSE operates automatically according to a programmed logic to ensure proper operations of the device. In a manual mode, the TSE can receive user's input via operation interfaces, for example, to convert a state of the switch therein, to perform maintenance such as drawing the TSE out of the cabinet and the like. However, during the manual mode of the TSE, there is a risk of wrong operations by the user. This is because almost all parts of the TSE are disposed in a power distribution cabinet and cannot be observed by the user and only the operation interfaces can be accessed by the user. The user thus normally does not know the actual states of the TSE. There is a need to improve safety operations of the TSE.

### SUMMARY

Example embodiments of the present disclosure provide a dual power transfer switch which can improve operation safety of the device by providing an interlock function.

In a first aspect of the present disclosure, it is provided a dual power transfer switch. The dual power transfer switch comprises a contact system comprising a contact main shaft rotatably arranged to move contact assemblies, wherein the contact main shaft comprises a first closed position, a second closed position, and an open position, wherein at the first closed position, the contact assemblies connect a first power source to a load; at the second closed position, the contact assemblies connect a second power source to the load, and at the open position, the contact assemblies disconnects both the first power supply and the second power supply from the load; a contact main shaft locking device configured to keep the contact main shaft at the open position and including a locking link and a first actuator adapted to actuate the locking link to engage with the contact main shaft so as to lock the contact main shaft at the open position; and a contact main shaft interlock device adapted to cooperate with the contact main shaft locking device to selectively lock or unlock the contact main shaft locking device.

According to the present disclosure, during operation of the dual power transfer switch, the contact main shaft interlock device is operated to selectively to lock or unlock the contact main shaft locking device. Accordingly, the operation of the contact main shaft locking device is restricted by an additional interlock mechanism, which improves the safety of the dual power transfer switch.

In some embodiments, the first actuator comprises a first electromagnetic actuator. A first actuating link of the first electromagnetic actuator is configured to move the locking link into or out of engagement with the locking link in response to an input to the first electromagnetic actuator; and the contact main shaft interlock device includes a first interlock link and a second actuator adapted to actuate the first interlock link, the first interlock link being adapted to engage with the first actuating link of the first electromagnetic actuator such that the first actuating link cannot be actuated by the first electromagnetic actuator. With the arrangement, by acting upon the first actuating link of the first electromagnetic actuator, the contact main shaft interlock device can lock or unlock the contact main shaft locking device with a simple structure.

In some embodiments, the second actuator comprises a second electromagnetic actuator, a second actuating link of the second electromagnetic actuator being configured to move the first interlock link in response to an input to second electromagnetic actuator. Due to good responsiveness of the electromagnetic actuator, the second actuator can respond timely to meet time efficiency requirements of the interlock functionality.

In some embodiments, the first actuating link comprises a hook portion protruding from a body of the first actuating link, and the first interlock link comprises an engaging portion that mates with the hook portion. With this arrangement, the reliability and robustness of the interlock can be ensured.

In some embodiments, the first interlock link is spring-biased and rotatably mounted to a fixed part (for example, a carrier of the dual power transfer switch) of the dual power transfer switch. Due to the spring-biased and rotatable arrangement, the space efficiency of the interlock device is improved.

In some embodiments, the locking link is rotatably mounted to a fixed part (for example, a carrier of the dual power transfer switch) of the dual power transfer switch. With this arrangement, the space efficiency of the interlock device is improved and also, the locking link can be driven with a simple configuration.

In a second aspect of the present disclosure, it is provided a dual power transfer switch. The dual power transfer switch comprises: a charging system comprising a charging main shaft and a charging element, the charging main shaft being configured to be rotated by the charging element, wherein the charging main shaft comprises a first energy release position, a second energy release position and a charging position between the first energy release position and the second energy release position; a contact system comprising a contact main shaft which is adapted to be rotated by the charging main shaft via a transmission system so as to move contact assemblies, wherein the contact main shaft comprises a first closed position, a second closed position, and an open position, wherein at the first closed position, the contact assemblies connect a first power source to a load; at the second closed position, the contact assemblies connect a second power source connected to the load; and in the open position, the contact assemblies disconnects both the first power supply and the second power supply from the load, and wherein the first energy release position and the second energy release position correspond to the first closed position and the second closed position, respectively; and a charging main shaft interlock device comprising an interlock link adapted to move toward or away from the charging main shaft, the interlock link being selectively located in a rotation path of the charging main shaft so as to prevent the charging main shaft from moving.

According to the present disclosure, during operation of the dual power transfer switch, the interlock link of the charging main shaft interlock device can move toward or away from the charging main shaft so as to prevent or allow the charging main shaft from moving. Accordingly, the movement of the charging main shaft can be limited properly, which can improve safety of the dual power transfer switch.

In some embodiments, the charging main shaft comprises a protrusion radially projecting from a body of the charging main shaft, the interlock link being configured to engage the protrusion so as to prevent the charging main shaft from moving. With this arrangement, by radial protrusion, the charging main shaft can be limited without any interference of the normal operation of the charging system.

In some embodiments, the charging main shaft interlock device comprises a carrier fixedly mounted to the dual power transfer switch, the interlock link slidably disposed in the carrier, the interlock link being actuated to selectively be located at an extended position in which the interlock link engages with the charging main shaft and a retracted position in which the interlock link is away from the charging main shaft and thus disengages from the charging main shaft. With this arrangement, the provision of the interlock does not affect the normal operation of the charging system and can be realized with a simple configuration.

In some embodiments, the carrier comprises a notch for axial extension of the charging main shaft and a slot opening to the notch, the interlock link being configured to be actuated to move in the slot between the extended position and the retracted position, the notch of the carrier preferably being formed in an arcuate shape. Due to the notch, sufficient space is left for rotation of the charging main shaft and the space efficiency of the dual power transfer switch can be improved.

In some embodiments, the charging main shaft interlock device comprises an interlock actuating assembly which comprises an electromagnetic actuator and a transmission mechanism, an actuating link of the electromagnetic actuator being configured to drive the transmission mechanism in response to an input to the electromagnetic actuator, the transmission mechanism being mounted on the carrier and comprising a linkage mechanism for actuating the interlock link. Due to good responsiveness of the electromagnetic actuator, the second actuator can respond timely to meet time efficiency requirements of the interlock functionality.

In some embodiments, the linkage mechanism comprises: a first link mounted in a spring-biased manner on the carrier and adapted to be moved linearly relative to the carrier via the actuating link; and a second link rotatably mounted on the carrier and adapted to rotate in response to a linear movement of the first link so as to move the interlock link via a rotational movement of the second link. With the arrangement, the interlock link can be driven with a compact structure.

In some embodiments, the second link is fitted to the first link through a first shaft-hole engagement. In some embodiments, the interlock link is fitted to the second link through a second shaft-hole engagement. The first and second shaft-hole engagements provide reliable force transmission from the actuator to the interlock link.

In some embodiments, the charging system further comprises a charging actuator for charging the charging element; and the interlock actuator and the charging actuator operate independently of each other.

In a third aspect of the present disclosure, it is provided a power distribution cabinet. The power distribution cabinet comprises: a first power supply terminal for receiving a first power from a first power supply; a second power supply terminal for receiving a second power from a second power supply; a load terminal for outputting a power to a load; at least one dual power transfer switch according to any of the above mentioned first and second aspects configured to selectively connect the first power terminal or the second power terminal to the load terminal.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic view of a bypass device including two TSEs showing operation principles of the device.

FIG. 2 schematically illustrates a perspective view of a TSE viewed from a charging main shaft side according to an embodiment of the present disclosure;

FIG. 3 schematically illustrates a perspective view of a TSE viewed from a contact main shaft side according to an embodiment of the present disclosure;

FIG. 4 schematically illustrates a perspective view viewed from the contact main shaft side of a contact main shaft interlock device and a charging main shaft interlock device according to an embodiment of the present disclosure;

FIG. 5 schematically illustrates a perspective view of a contact main shaft interlock device according to an embodiment of the present disclosure with the contact main shaft interlock device at a locked state;

FIG. 6 schematically illustrates a perspective view of a contact main shaft interlock device according to an embodiment of the present disclosure with the contact main shaft interlock device at a unlocked state;

FIG. 7 schematically illustrates a closed up view of a charging system with the charging main shaft interlock device according to an embodiment of the present disclosure;

FIG. 8 schematically illustrates a view viewed from a charging main shaft side of a charging main shaft interlock device and a contact main shaft interlock device according to an embodiment of the present disclosure with both the charging main shaft interlock device and the contact main shaft interlock device at a locked state;

FIG. 9 schematically illustrates a closed up view viewed from a charging main shaft side of a charging main shaft interlock device according to an embodiment of the present disclosure with the charging main shaft interlock device at a locked state;

FIG. 10 schematically illustrates a closed up view viewed from a charging main shaft side of a charging main shaft interlock device according to an embodiment of the present disclosure with the charging main shaft interlock device at a unlocked state;

FIG. 11 schematically illustrates an exploded view of the charging main shaft interlock device according to an embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

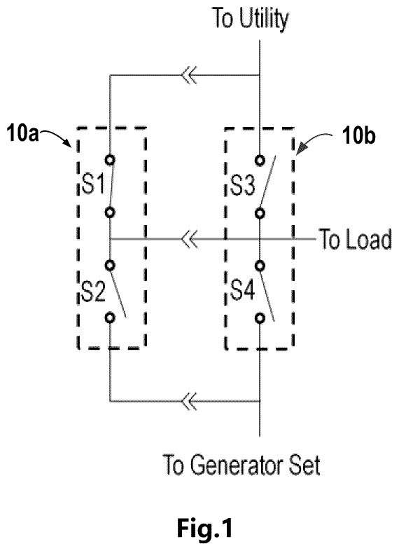

First of all, an application scenario according to an embodiment of the present disclosure will be described with reference to FIG. 1. As shown in FIG. 1, a bypass device comprises two dual power transfer switches 10a, 10b (also referred to as transfer switching equipment, TSE). The two TSEs 10a, 10b are substantially the same and are implemented as a drawer which can be slidably arranged in a power distribution cabinet. A first TSE 10a comprises a first switch S1 and a second switch S2, and the second TSE 10b comprises a third switch S3 and a fourth switch S4. Terminals of the first switch S1 and the third switch S3 are connected to a main power supply, for example, the utility or mains supply, and the second switch S2 and the fourth switch S4 are connected to an auxiliary power supply, for example, a generator set.

During a normal condition, the first TSE 10a is used to switch the load between the main power supply and the auxiliary power supply. That is, when the main power supply is a normal state, the first switch S1 is closed (also referred to as being switched on) and the second switch S2 is opened (also referred to as being switched off), such that the load is powered by the main power supply; when the main power supply is an abnormal state, the first switch S1 is opened and the second switch S2 is closed, such that the load is powered by the auxiliary power supply. In this situation, the third switch S3 and the fourth switch S4 of the second TSE 10b both are opened.

The two TSEs 10a, 10b may operate in an automatic mode and a manual mode. In the automatic mode, the TSEs operate automatically according to a programmed logic to ensure proper operations of the device. In the manual mode, the TSE can receive user's input via operation interface 70, for example, to convert a state of the switch therein in case of maintenance.

When the first TSE needs maintenance, both the first and second switches S1, S2 should be open before any actions are taken by a user. However, the user may mistakenly take actions to operate the first and second switches S1, S2 so as to convert a state of the first and second switches S1, S2 to be closed. In the event that any of the first and second switches S1, S2 is closed, when the user swung out the drawer (i.e, the TSE), it is dangerous and may cause casualties. Thus, there is a need to prevent the user's wrong operations. On the other hand, when the first TSE 10a needs maintenance, one of the third and fourth switches S3, S4 of the second TSE 10b should be closed and the other should be open to ensure continuous power supply to the loads. However, the user may mistakenly take actions to operate the third and fourth switches S3, S4 so as to convert both the third and fourth switches S3, S4 to be open. This may cause an interruption of power supply to the critical loads. Thus, there is also a need to prevent the user's wrong operations.

Likewise, when the second TSE needs maintenance, both the third and fourth switches S3, S4 should be open before any actions are taken by a user. However, the user may mistakenly take actions to operate the third and fourth switches S3, S4 so as to convert a state of the third and fourth switches S3, S4 to be closed. Thus, there is a need to prevent the user's wrong operations. On the other hand, as the second TSE needs maintenance, one of the first and second switches S1, S2 should be closed and the other should be open to ensure continuous power supply to the loads. However, the user may mistakenly take actions to operate the first and second switches S1, S2 so as to convert both the first and second switches S1, S2 to be open. Thus, there is also a need to prevent the user's wrong operations.

According to one embodiment of the present disclosure, it is provided a dual power transfer switch with interlock functions which can prevent user's wrong operations of the device. An interlock device is provided for interlock the dual power switch. The interlock device is configured to lock or unlock the dual power switch in dependence on the states of the dual power transfer switch.

In some embodiments, for example, when the switch S1 of the first TSE 10a is at ON state (i.e., closed), the switch S1 cannot be converted to OFF state (i.e., open) or to ON sate of the switch S2. Likewise, when the switch S2 of first TSE is at ON state (i.e., closed), the switch S2 cannot be converted to OFF state (i.e., open) or to ON sate of the switch S1. In some embodiments, for example, only when both the switches S1, S2 of first TSE is at OFF state (open), the first TSE 10a can be operated by the user so as to be drawn out of the cabinet. Likewise, only when both the switches S3, S4 of second TSE is at OFF state (open), the second TSE 10b can be operated by the user so as to be drawn out of the cabinet. It is to be understood that the interlock functions may be applicable to any TSE of the bypass device.

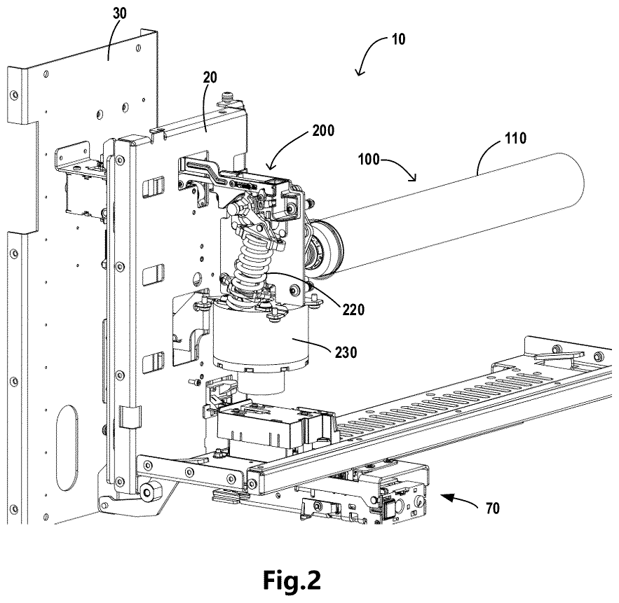

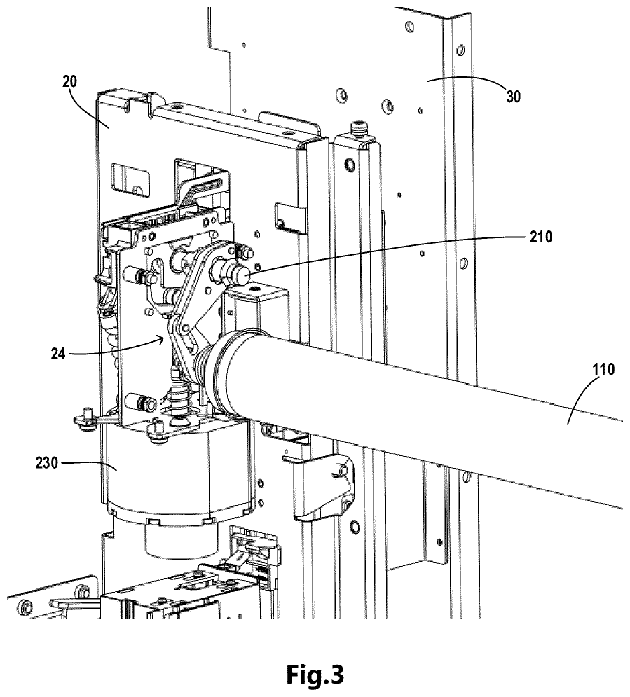

FIGS. 2 and 3 schematically illustrate a perspective view of a TSE 10 according to an embodiment of the present disclosure viewed from a charging main shaft side from a contact main shaft side respectively. As shown in FIGS. 2 and 3, the TSE 10 is arranged on a carriage and is implemented as a drawer. The TSE 10 moves along a guide rail in a power distribution cabinet. The user can operates a user interface 70 to operate the TSE 10. In FIGS. 2 and 3, only a frame 30 of the cabinet is shown and other unrelated parts of the cabinet are omitted for sake of clarity.

The TSE 10 includes a contact system 100 and a charging system 200 for driving the movable contact assemblies of the contact system 100. The contact system 100 includes a movable contact (now shown), a first fixed contact for connecting to a first power supply, and a second fixed contact for connecting to a second power supply. The movable contact can be driven by a contact main shaft 110 which is rotatably arranged on the carriage. Accordingly to the phase number of the TSE, the number of the movable contacts, the number of the first fixed contacts, and the number of the second fixed contacts vary. During operation of the TSE 10, a rotation of the contact main shaft 110 cause the movable contact to be located at different positions via a contact link mechanism. The contact main shaft 110 includes a first closed position, a second closed position, and an open position, wherein at the first closed position, the contact assemblies connect a first power source to a load; at the second closed position, the contact assemblies connect a second power source to the load, and at the open position, the contact assemblies disconnects both the first power supply and the second power supply from the load. As these contact assemblies and the associated contact link mechanisms are well known in the art and are omitted in the figures in order not to obscure the principle of the invention.

The charging system 200 includes a charging main shaft 210 and a charging element 220. The charging system 200 may be arranged on a mounting plate 20. In the shown example, the charging element 220 is shown as a charging spring which can be operated to automatically store energy via operation of an actuator 230. During operation of the charging system 200, the charging element 220 is firstly charged. The charging element 220 drives the charging main shaft 210 to rotate through energy release of the charging element 220 and a rotation of the charging main shaft 210 further causes the contact main shaft 110 to rotate via a transmission mechanism 240. The charging main shaft 210 includes a first energy release position, a second energy release position and a charging position between the first energy release position and the second energy release position. In some embodiments, the first energy release position is corresponding to the first closed position of the contact main shaft 110, the second energy release position is corresponding to the second closed position of the contact main shaft 110, and the charging position is located between the first energy release position and the second energy release position. The transmission mechanism 24 may take various forms. In the shown example, the transmission mechanism 24 includes a link mechanism.

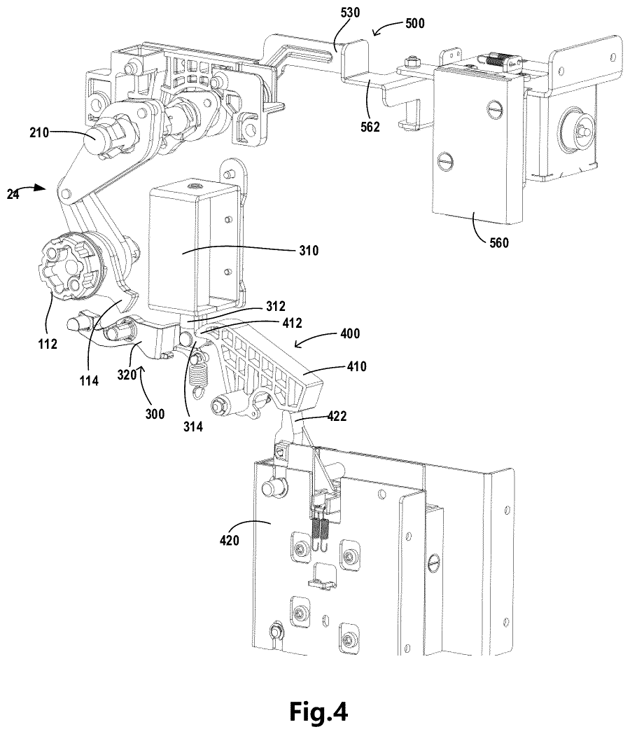

FIG. 4 schematically illustrates a perspective view viewed from the contact main shaft side of a contact main shaft interlock device 400 and a charging main shaft interlock device 500 according to an embodiment of the present disclosure.

As shown in FIG. 4, the TSE 10 further includes a contact main shaft locking device 300. As mentioned above, the contact main shaft 110 is driven by the charging main shaft 210 via the transmission mechanism 240. In order to keep the contact main shaft 110 at the open position at which the movable contacts disconnect both the first fixed contacts and the second fixed contacts, the contact main shaft locking device 300 is provided.

In FIG. 4, the contact main shaft locking device 300 includes a locking link 320 and a first actuator 310. The first actuator 310 is configured to actuate the locking link 320 to engage with the contact main shaft 110 so as to lock the contact main shaft 110 at the open position. In the shown example, oration of the charging main shaft 210 is transmitted to a sub contact main shaft 112 which is fixedly coupled to the contact main shaft 110 to cause the sub contact main shaft 112 to rotate. The sub contact main shaft 112 comprises a tripping arm 114. When the movable contacts of the contact system is disengaged from both the first fixed contacts and the second fixed contacts (i.e., both switches in each TSE are open, such as the switches S1 and S2 of the first TSE, or the switches S3 and S4 of the second TSE), the locking link 320 is actuated to engage with the tripping arm 114 so as to lock the contact main shaft 110 at the open position. Only at this state of the TSE, the user is allowed to withdraw the TSE from the cabinet.

As shown in FIG. 4, the TSE 10 further includes a contact main shaft interlock device 400. The contact main shaft interlock device 400 is configured to cooperate with the contact main shaft locking device 300 to selectively lock or unlock the contact main shaft locking device 300. The term “lock the contact main shaft locking device 300” means the locking link 320 cannot be moved to disengage from the contact main shaft 110. In this event, regardless of how the user operates the user interface, the locking link 320 keeps engaging with the contact main shaft 110. The contact main shaft 110 thus cannot move the movable contracts. Hence, the TSE 10 is kept at the open state. Likewise, the term “unlock the contact main shaft locking device 300” means the contact main shaft locking device 300 is not affected by the contact main shaft interlock device 400 any longer.

By provision of the contact main shaft interlock device, the contact main shaft locking device 300 can be maintained at a certain position independently. Accordingly, without unlocking the contact main shaft locking device 300 by operation of the contact main shaft interlock device, the open state of the TSE 10 cannot be changed, for example, to the first and second closed state. Accordingly, the safety can be improved.

In some embodiments, as shown in FIG. 4, the locking link 320 is rotatably mounted to the dual power transfer switch. The first actuator 310 includes a first electromagnetic actuator, and a first actuating link 312 of the first electromagnetic actuator is configured to move the locking link 320 into or out of engagement with the locking link 320 in response to an input to the first electromagnetic actuator. This arrangement is advantageous since the time required for operation of the electromagnetic actuator is less and meet operation requirements of the TSE.

There are many ways for implementing the contact main shaft interlock device 400. In the shown example, as shown in FIG. 4, the contact main shaft interlock device 400 may include a first interlock link 410 and a second actuator 420 adapted to actuate the first interlock link 410. The first interlock link 410 is adapted to engage with the first actuating link 312 of the first electromagnetic actuator such that the first actuating link 312 cannot be actuated by the first electromagnetic actuator. In this way, by stopping the movement of the first actuating link 312 of the first actuator with the first interlock link 410, the first actuating link 312 cannot be moved regardless of commends to the first actuator 310. In some embodiments, instead of stopping the first actuating link 312, the locking link 320 can be stopped by proper means.

In some embodiments, as shown in FIG. 4, the second actuator 420 includes a second electromagnetic actuator and a second actuating link 422 of the second electromagnetic actuator is configured to move the first interlock link 410 in response to an input to second electromagnetic actuator. It is to be understood that the second actuator 420 being an electromagnetic actuator is merely exemplary and it may take other forms, such as pneumatic actuator or motor as long as it can realize the function of locking and unlocking the contact main shaft locking device 300.

In some embodiments, as shown in FIG. 4, the first actuating link 312 includes a hook portion 314 protruding from a body of the first actuating link 312, and the first interlock link 410 includes an engaging portion 412 that mates with the hook portion 314. By provisions of the hook portion 314 and the engaging portion 412, it may facilitate the reliable engagement between the first actuating link 312 and the first interlock link 410. It is to be understood that the shape of the hook portion 314 may take any proper shapes in addition of the hook shape as shown in the figures.

In some embodiments, as shown in FIG. 4, the first interlock link 410 is spring-biased and rotatably mounted to the dual power transfer switch. By rotation actuation of the first interlock link 410, it can be easily implemented as a compact structure without occupying too much space. Also, it can easily to reset the position of the first interlock link 410 by the elastic return force of the spring. It is to be understood that first interlock link 410 may take any proper implementations, for example, can be driven by a linear movable instead of a rotation movement.

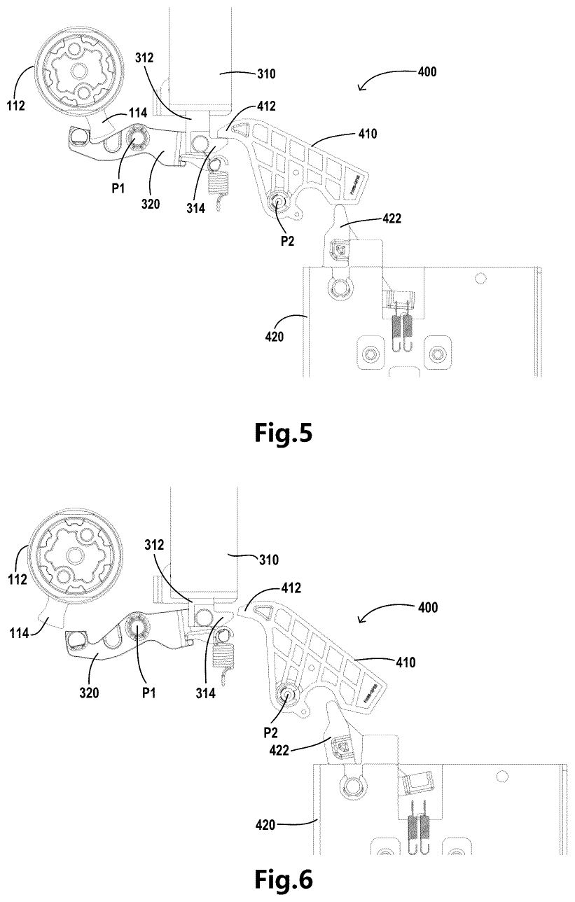

The interlock operations of the contact main shaft interlock device 400 are described below with reference to FIGS. 4-6. FIGS. 5 and 6 schematically illustrate a perspective view of a contact main shaft interlock device with the contact main shaft interlock device at a locked state and a unlocked state respectively. In some embodiments, as shown in FIG. 4, the contact main shaft interlock device 400 is provided close to the sub contact main shaft 112. This is advantageous since the provision of the contact main shaft interlock device 400 can be easily realized without affecting the contact system.

During operation of the TSE 10, when the contact main shaft locking device 300 locks the contact main shaft 110 or the sub contact main shaft 112 into an open position (at which the movable contacts of the contact system does not connect to any of the fixed contacts), the second actuator 420 operates to move its second actuating link 422 upward, the first interlock link 410 rotates anticlockwise so as to engage with the first actuator 310. In the shown example, as shown in FIG. 5, the engaging portion 412 engages with the hook portion 314 of the first actuating link 312. The first actuating link 312 is stopped from moving regardless of the input commends to the first actuator 310.

As shown in FIG. 6, when the locking of the contact main shaft locking device 300 is not needed, the second actuator 420 operates to move its second actuating link 422 downward, the first interlock link 410 rotates clockwise so as to disengage from the first actuator 310. In the shown example, as shown in FIG. 6, the engaging portion 412 disengages from the hook portion 314 of the first actuating link 312. The first actuating link 312 is not limited by the engaging portion 412 any longer. In this event, the first actuator 310 can be actuated in response to input commends. In this event, the contact main shaft 110 or the sub contact main shaft 112 is allowed to convert to a first/second closed position from the open position.

In addition to the contact main shaft interlock device 400 which is configured to lock the contact main shaft 110 at the open position, there is provided a charging main shaft interlock device 500 which is configured to lock the contact main shaft 110 at an energy release position. The charging main shaft interlock device 500 can be provided individually. Thus, the safety of the TSE 10 is further improved.

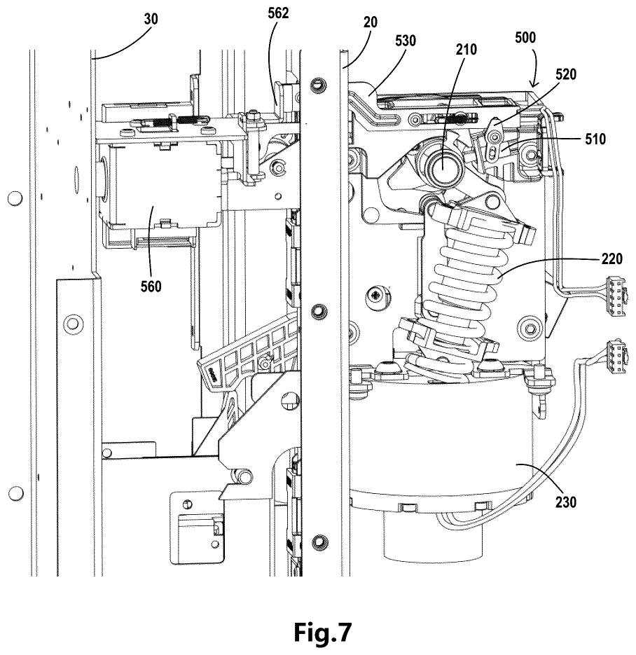

With reference to FIGS. 4 and 7, the TSE 10 may further include a charging main shaft interlock device 500. The charging main shaft interlock device 500 is provided to implement interlock of the TSE 10 at the charging main shaft side. As shown in FIGS. 4 and 7, the charging main shaft interlock device 500 includes an interlock link 510. The interlock link 510 is configured to move toward or away from the charging main shaft 210 so as to be located in a rotation path of the charging main shaft 210 to prevent the charging main shaft 210 from moving.

As mentioned above, the charging main shaft 210 is moved by energy release from the charging element 220. By energy release of the charging element 220, the charging main shaft 210 is rotated to a first energy release position and a second energy release position which correspond to the first closed position and the second position of the contact main shaft respectively. For example, when the charging main shaft 210 is located at the first (i.e., the TSE is at a first closed position), the user may mistakenly move the charging main shaft 210 to an open position. This should be prevented since this may cause power supply interruption of the load. According to one embodiment of the present disclosure, by provision of provision of the interlock link 510, the movement of the charging main shaft 210 can be interlocked. The interlock link 510 is independently operated with respect to the charging spring. By control the movement of the interlock link 510, the safety of the TSE can be improved.

The charging main shaft interlock device 500 may include an actuating assembly for moving the interlock link 510. There are many ways for implementing the actuating assembly as long as the actuating assembly can move the interlock link 510 toward and away from the charging main shaft 210. In some embodiments, interlock link 510 moves linearly. It is to be understood that this is merely exemplary, as long as the interlock link 510 can move into the rotation path of the charging main shaft 210. In some example, interlock link 510 performs rotation.

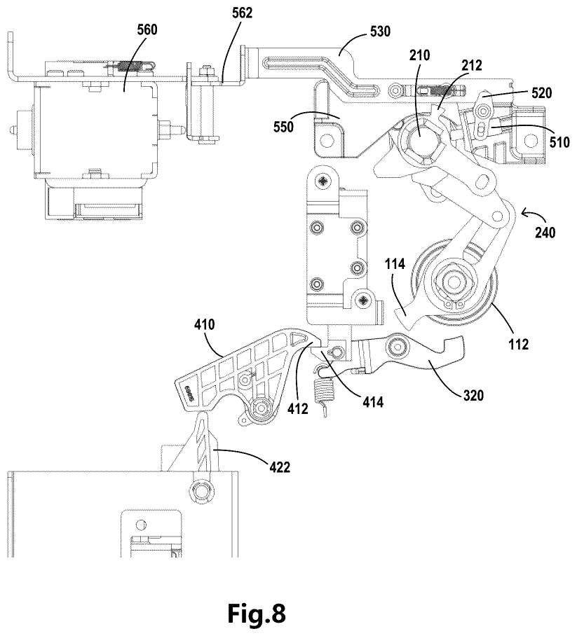

In some embodiments, as shown in FIGS. 7 and 8, the charging main shaft 210 includes a protrusion 212 radially projecting from a body of the charging main shaft 210. The interlock link 510 is configured to engage the protrusion 212 so as to prevent the charging main shaft 210 from moving. In this way, the structural design freedom for the interlock link 510 can be improved since it does not have to move too close to the charging main shaft 210.

In some embodiments, as shown in FIGS. 7-10, the charging main shaft interlock device 500 includes a carrier 550 fixedly mounted to the dual power transfer switch. The interlock link 510 is slidably disposed in the carrier 550. The interlock link 510 is actuated to be selectively located at an extended position in which the interlock link 510 engages with the charging main shaft 210 and a retracted position in which the interlock link 510 is away from the charging main shaft 210 and thus disengages from the charging main shaft 210. By the provision of the carrier and slidable arrangement of the interlock link 510, the provision of the charging main shaft interlock device 500 can be implemented without affecting the proper normal operations of the charging system 200.

In some embodiments, as shown in FIGS. 7-10, the carrier 550 includes a notch 552 for axial extension of the charging main shaft 210 and a slot 554 opening to the notch 552. The interlock link 510 is configured to be actuated to move in the slot 554 between the extended position and the retracted position. By provision of the slot 554, the movement of the interlock link 510 can be guided. Also, space occupied by the charging main shaft interlock device 500 is reduced. In some embodiments, the notch 552 of the carrier 550 is formed in an arcuate shape. It is to be understood that this is merely exemplary.

In some embodiments, as shown in FIGS. 7-10, the actuating assembly includes an electromagnetic actuator 560 and a transmission mechanism. An actuating link 562 of the electromagnetic actuator 560 is configured to drive the transmission mechanism in response to an input to the electromagnetic actuator 560. Use of electromagnetic actuator 560 may be advantageous due to its good response performances. It is to be understood that this is merely exemplary, the actuator 560 may use other actuating forms. The transmission mechanism may be mounted on the carrier 550 and includes a linkage mechanism for actuating the interlock link 510. With such arrangement, the interlock link 510 can be driven in a simple way without affecting the proper normal operations of the charging system 200.

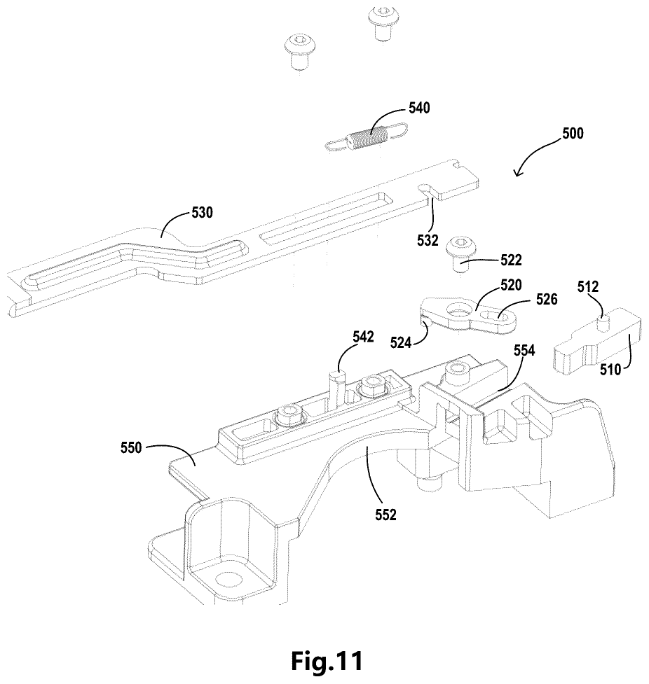

In some embodiments, as shown in FIGS. 7-10, the linkage mechanism includes a first link 530 and a second link 520. The first link 530 is mounted in a spring-biased manner on the carrier 550 and is configured to be moved linearly relative to the carrier 550 via the actuating link 562. As shown in FIG. 11, a spring is arranged between a engagement part 542 of the carrier and the first link 530. The second link 520 is rotatably mounted on the carrier 550 and is configured to rotate in response to a linear movement of the first link 530 so as to move the interlock link 510 via a rotational movement of the second link 520.

In some embodiments, as shown in FIG. 11, the second link 520 is fitted to the first link 530 through a first shaft-hole engagement. As shown, the first link 530 may comprises an opening 532 and a shaft 524 is provided on the second link 520. The interlock link 510 is fitted to the second link 520 through a second shaft-hole engagement. As shown, the interlock link 510 may comprises a shaft 512 and an opening 526 is provided on the second link 520. It is to be understood the opening 532 and a shaft 524 and the shaft 512 and an opening 526 are merely illustrative and the first and second shaft-hole engagements may include other proper forms as long as the required relative rotation movement can be realized.

The interlock operations of the charging main shaft interlock device 500 are described below with reference to FIGS. 7-10.

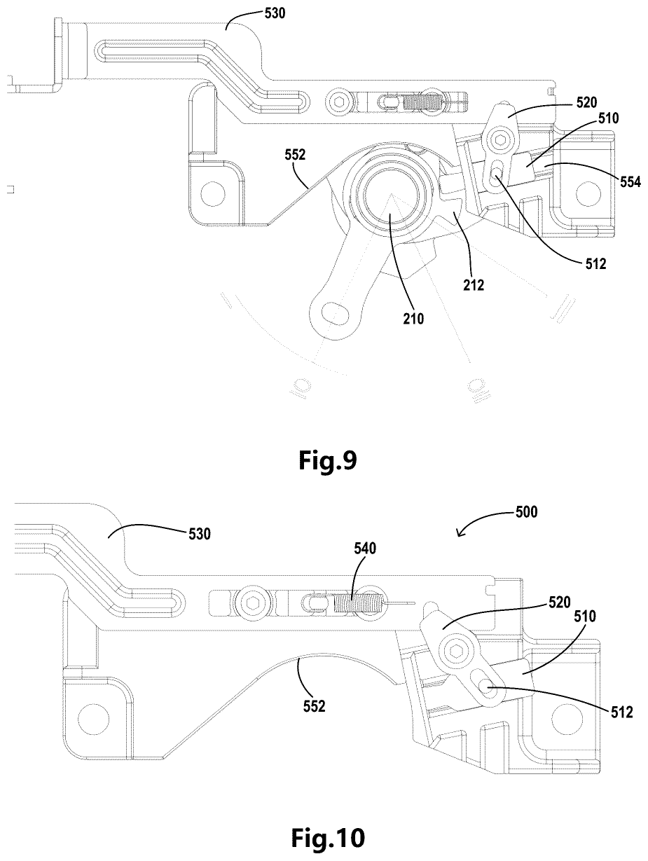

During operation of the TSE 10, as shown in FIGS. 7 and 8, the charging main shaft 210 is located at the second energy release position (corresponding to position II in FIG. 9) and the TSE 10 is at the second closed position (at which the movable contacts of the contact system is connected to the fixed contacts), the interlock link 510 is actuated to be located at an extended position in which the interlock link 510 can engage with the charging main shaft 210 when the charging main shaft 210 rotates. Accordingly, the interlock link (510) is located in a rotation path of the charging main shaft (210). The charging main shaft (210) thus is prevented from converting to other positions (such as position OII which corresponds to the second open position, or position IO which corresponds to the first open position, or the position I which corresponds to the first position.

In the shown example, in order to move the interlock link 510 to the extended position, the electromagnetic actuator 560 first moves the actuating link 562. A linear movement of the actuating link 562 moves the first link 530 linearly. The linear movement of the first link 530 rotates the second link 520 which in turn moves the interlock link 510 linearly toward the charging main shaft 210. Accordingly, the interlock link 510 is in the rotation path of the charging main shaft 210. Even if the user operates the charging main shaft 210 by mistake, during the rotation of the charging main shaft 210, the charging main shaft 210 meets the charging main shaft 210 which stops the charging main shaft 210 from further rotating. Thus, the charging main shaft 210 cannot be converted to other operation states.

As shown in FIG. 9, when the charging main shaft 210 indeed needs to move to the position IO, the interlock link 510 is actuated to be located at a retracted position in which the interlock link 510 disengages with the charging main shaft 210. Accordingly, the interlock link 510 is out of the rotation path of the charging main shaft 210. The charging main shaft 210 thus is allowed to be converted to other positions such as position IO. It is to be understood, the positions I, II, OI, OII are merely illustrative. According to the number and the arrangement of the charging element, the positions and the number of these positions may vary.

In the shown example, likewise, in order to retract the interlock link 510 to the retracted position, the first link 530 can move linearly leftward (in the shown figures) and the leftward linear movement causes the second link 520 to rotate counterclockwise. The counterclockwise rotation of the second link 520 cause the interlock link 510 moves rightward and thus retracts from the extended position. Accordingly, the interlock link 510 is out of the rotation path of the charging main shaft 210, and the charging main shaft 210 is thus allowed to rotate to other positions so as to convert the states of the movable contacts to other operation states.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. A dual power transfer switch, comprising:
a contact system including a contact main shaft rotatably arranged to move contact assemblies, wherein the contact main shaft comprises a first closed position, a second closed position, and an open position, wherein at the first closed position, the contact assemblies connect a first power source to a load, at the second closed position, the contact assemblies connect a second power source to the load, and at the open position, the contact assemblies disconnects both the first power supply and the second power supply from the load;
a contact main shaft locking device configured to keep the contact main shaft at the open position and including a locking link and a first actuator adapted to actuate the locking link to engage with the contact main shaft so as to lock the contact main shaft at the open position; and
a contact main shaft interlock device adapted to cooperate with the contact main shaft locking device to selectively lock or unlock the contact main shaft locking device.

2. The dual power transfer switch of claim 1,
wherein the first actuator comprises a first electromagnetic actuator having a first actuating link configured to move the locking link into or out of engagement with the locking link in response to an input to the first electromagnetic actuator; and
wherein the contact main shaft interlock device comprises a first interlock link and a second actuator adapted to actuate the first interlock link, the first interlock link being adapted to engage with the first actuating link of the first electromagnetic actuator such that the first actuating link cannot be actuated by the first electromagnetic actuator.

3. The dual power transfer switch of claim 2, wherein the second actuator comprises a second electromagnetic actuator having a second actuating link configured to move the first interlock link in response to an input to second electromagnetic actuator.

4. The dual power transfer switch of claim 2, wherein the first actuating link comprises a hook portion protruding from a body of the first actuating link, and the first interlock link comprises an engaging portion that mates with the hook portion.

5. The dual power transfer switch of claim 2, wherein the first interlock link is spring-biased and rotatably mounted to a fixed part of the dual power transfer switch.

6. The dual power transfer switch of claim 1, wherein the locking link is rotatably mounted to a fixed part of the dual power transfer switch.

7. The dual power transfer switch of claim 1, wherein the first actuator and the second actuator operate independently of each other.

8. A dual power transfer switch, comprising:
a charging system comprising a charging main shaft and a charging element, the charging main shaft being configured to be rotated by the charging element, wherein the charging main shaft comprises a first energy release position, a second energy release position and a charging position between the first energy release position and the second energy release position;
a contact system comprising a contact main shaft which is adapted to be rotated by the charging main shaft via a transmission system so as to move contact assemblies, wherein the contact main shaft comprises a first closed position, a second closed position, and an open position, wherein at the first closed position, the contact assemblies connect a first power source to a load; at the second closed position, the contact assemblies connect a second power source connected to the load; and in the open position, the contact assemblies disconnects both the first power supply and the second power supply from the load, and wherein the first energy release position and the second energy release position correspond to the first closed position and the second closed position, respectively; and
a charging main shaft interlock device comprising an interlock link adapted to move toward or away from the charging main shaft, the interlock link being selectively located in a rotation path of the charging main shaft so as to prevent the charging main shaft from moving.

9. The dual power transfer switch of claim 8, wherein the charging main shaft comprises a protrusion radially projecting from a body of the charging main shaft, the interlock link being configured to engage the protrusion so as to prevent the charging main shaft from moving.

10. The dual power transfer switch of claim 8, wherein the charging main shaft interlock device comprises a carrier fixedly mounted to the dual power transfer switch, the interlock link slidably disposed in the carrier, the interlock link being actuated to be selectively located at an extended position in which the interlock link engages with the charging main shaft and a retracted position in which the interlock link is away from the charging main shaft.

11. The dual power transfer switch of claim 10, wherein the carrier comprises a notch for axial extension of the charging main shaft and a slot opening to the notch, the interlock link being configured to be actuated to move in the slot between the extended position and the retracted position, the notch of the carrier preferably being formed in an arcuate shape.

12. The dual power transfer switch of claim 10, wherein the charging main shaft interlock device comprises an interlock actuating assembly which comprises an electromagnetic actuator and a transmission mechanism, an actuating link of the electromagnetic actuator being configured to drive the transmission mechanism in response to an input to the electromagnetic actuator, the transmission mechanism being mounted on the carrier and comprising a linkage mechanism for actuating the interlock link.

13. The dual power transfer switch of claim 12, wherein the linkage mechanism comprises:
a first link mounted in a spring-biased manner on the carrier and adapted to be moved linearly relative to the carrier via the actuating link; and
a second link rotatably mounted on the carrier and adapted to rotate in response to a linear movement of the first link so as to move the interlock link via a rotational movement of the second link.

14. The dual power transfer switch of claim 14, wherein the second link is fitted to the first link through a first shaft-hole engagement.

15. The dual power transfer switch of claim 14, wherein the interlock link is fitted to the second link through a second shaft-hole engagement.

16. The dual power transfer switch of claim 12, wherein the charging system further comprises a charging actuator for charging the charging element, the electromagnetic actuator and the charging actuator operate independently of each other.

17. A power distribution cabinet, comprising:
a first power supply terminal for receiving a first power from a first power supply;
a second power supply terminal for receiving a second power from a second power supply;
a load terminal for outputting a power to a load;
at least one dual power transfer switch according to claim 1 configured to selectively connect the first power terminal or the second power terminal to the load terminal.
